(19) United States
(12) Patent Application Publication
(10) Pub. No.: US 2016/0011876 A1
(43) Pub. Date: Jan. 14, 2016

(54) MANAGING INSTRUCTION ORDER IN A PROCESSOR PIPELINE

(71) Applicant: Cavium, Inc., San Jose, CA (US)

(72) Inventors: Shubhendu Sekhar Mukherjee, Southborough, MA (US); Richard Eugene Kessler, Northborough, MA (US); David Albert Carlson, Haslet, TX (US)

(21) Appl. No.: 14/328,951

(22) Filed: Jul. 11, 2014

(51) Int. Cl. G06F 9/38; G06F 9/30

(52) U.S. Cl. CPC G06F 9/3855; G06F 9/3869; G06F 9/30145

(57) ABSTRACT

Executing instructions in a processor includes classifying, in at least one stage of a pipeline of the processor, operations to be performed by instructions. The classifying includes: classifying a first set of operations as operations for which out-of-order execution is allowed, and classifying a second set of operations as operations for which out-of-order execution with respect to one or more specified operations is not allowed, the second set of operations including at least store operations. Results of instructions executed out-of-order are selected to commit the selected results in-order. The selecting includes, for a first result of a first instruction and a second result of a second instruction executed before and out-of-order relative to the first instruction: determining which stage of the pipeline stores the second result, and committing the first result directly from the determined stage over a forwarding path, before committing the second result.

### BACKGROUND

The invention relates to managing instruction order in a processor pipeline.

A processor pipeline includes multiple stages through which instructions advance, a cycle at a time. An instruction is fetched (e.g., in an instruction fetch (IF) stage or stages). An instruction is decoded (e.g., in an instruction decode (ID) stage or stages) to determine an operation and one or more operands. Alternatively, in some pipelines, the instruction fetch and instruction decode stages could overlap. An instruction has its operands fetched (e.g., in an operand fetch (OF) stage or stages). An instruction issues, which means that progress of the instruction through one or more stages of execution begins. Execution may involve apply its operation to its operand(s) for an arithmetic logic unit (ALU) instruction, or may involve storing or loading to or from a memory address for a memory instruction. Finally, an instruction is committed, which may involve storing a result (e.g., in a write back (WB) stage or stages).

In a scalar processor, instructions proceed one-by-one through the pipeline in-order according to a program (i.e., in program order), with at most a single instruction being committed per cycle. In a superscalar processor, multiple instructions may proceed through the same pipeline stage at the same time, allowing more than one instruction to issue per cycle, depending on certain conditions (called ‘hazards’), up to an ‘issue width’. Some superscalar processors issue instructions in-order, allowing successive instructions to proceed through the pipeline in program order, without allowing earlier instructions to pass later instructions. Some superscalar processors allow instructions to be reordered and issued out-of-order and allow instructions pass each other in the pipeline, which potentially increases overall pipeline throughput. If reordering is allowed, instructions can be reordered within a sliding ‘instruction window’, whose size can be larger than the issue width. In some processors, a reorder buffer is used to temporarily store results (and other information) associated with instructions in the instruction window to enable the instructions to be committed in-order (potentially allowing multiple instructions to be committed in the same cycle as long as they are contiguous in the program order).

### SUMMARY

In one aspect, in general, a method for executing instructions in a processor includes: classifying, in at least one stage of a pipeline of the processor, operations to be performed by instructions. The classifying includes: classifying a first set of operations as operations for which out-of-order execution is allowed, and classifying a second set of operations as operations for which out-of-order execution with respect to one or more specified operations is not allowed, the second set of operations including at least store operations. Results of instructions executed out-of-order are selected to commit the selected results in-order. The selecting includes, for a first result of a first instruction and a second result of a second instruction executed before and out-of-order relative to the first instruction: determining which stage of the pipeline stores the second result, and committing the first result directly from the determined stage over a forwarding path, before committing the second result.

Aspects can include one or more of the following features.

The second set of operations further includes load operations.

The method further includes selecting a plurality of instructions to be issued to one or more stages of the pipeline in which multiple sequences of instructions are executed in parallel through separate paths through the pipeline, based at least in part on a Boolean value provided by circuitry that applies logic to condition information stored in the processor representing conditions for multiple instructions in the set.

The condition information comprises one or more scoreboard tables.

The method further includes: determining identifiers corresponding to instructions in at least one decode stage of the pipeline, with a set of identifiers for at least one instruction including: at least one operation identifier identifying an operation to be performed by the instruction, at least one storage identifier identifying a storage location for storing an operand of the operation, and at least one storage identifier identifying a storage location for storing a result of the operation; and assigning a multi-dimensional identifier to at least one storage identifier.

The method further includes: determining identifiers corresponding to instructions in at least one decode stage of the pipeline, with a set of identifiers for at least one instruction including: at least one operation identifier identifying an operation to be performed by the instruction, at least one storage identifier identifying a storage location for storing an operand of the operation, and at least one storage identifier identifying a storage location for storing a result of the operation; and renaming at least one storage identifier to a physical storage identifier corresponding to a set of physical storage locations that has more physical storage locations than a total number of storage identifiers appearing in decoded instructions.

In another aspect, in general, a processor includes: circuitry in at least one stage of a pipeline of the processor configured to classify operations to be performed by instructions, the classifying including: classifying a first set of operations as operations for which out-of-order execution is allowed, and classifying a second set of operations as operations for which out-of-order execution with respect to one or more specified operations is not allowed, the second set of operations including at least store operations; and circuitry in at least one stage of the pipeline of the processor configured to select results of instructions executed out-of-order to commit the selected results in-order, the selecting including, for a first result of a first instruction and a second result of a second instruction executed before and out-of-order relative to the first instruction: determining which stage of the pipeline stores the second result, and committing the first result directly from the determined stage over a forwarding path, before committing the second result.

Aspects can include one or more of the following features.

The second set of operations further includes load operations.

The processor further includes: circuitry configured to select a plurality of instructions to be issued to one or more stages of the pipeline in which multiple sequences of instructions are executed in parallel through separate paths through the pipeline, based at least in part on a Boolean value provided by circuitry that applies logic to condition information stored in the processor representing conditions for multiple instructions in the set.

The condition information comprises one or more scoreboard tables.

The processor further includes: circuitry in at least one decode stage of the pipeline configured to determine identifiers corresponding to instructions, with a set of identifiers for at least one instruction including: at least one operation identifier identifying an operation to be performed by the instruction, at least one storage identifier identifying a storage location for storing an operand of the operation, and at least one storage identifier identifying a storage location for storing a result of the operation; and circuitry configured to assign a multi-dimensional identifier to at least one storage identifier.

The processor further includes: circuitry in at least one decode stage of the pipeline configured to determine identifiers corresponding to instructions, with a set of identifiers for at least one instruction including: at least one operation identifier identifying an operation to be performed by the instruction, at least one storage identifier identifying a storage location for storing an operand of the operation, and at least one storage identifier identifying a storage location for storing a result of the operation; and circuitry configured to rename at least one storage identifier to a physical storage identifier corresponding to a set of physical storage locations that has more physical storage locations than a total number of storage identifiers appearing in decoded instructions.

Aspects can have one or more of the following advantages.

In-order processors are typically more power-efficient compared to out-of-order processors that aggressively take advantage of instruction reordering in order to improve performance (e.g., using large instruction window sizes). However, allowing instructions to issue out-of-order, with limits on the window size and some changes to the pipeline circuitry (as described in more detail below), can still provide significant improvement in performance without substantially sacrificing power efficiency.

To illustrate the effects of reordering, the following example compares an in-order superscalar processor (with an instruction width of 2) to an out-of-order superscalar processor (also with an instruction width of 2). From the source code of a program to be executed, a compiler generates a list of executable instructions in a particular order (i.e., program order). Consider the following sequence of ALU instructions. In particular, ADD Rx←Ry+Rz indicates an instruction for which the ALU performs an addition operation by adding the contents of the registers Ry and Rz (i.e., Ry+Rz) and writing the result into the register Rx (i.e., Rx=Ry+Rz). The number preceding each instruction corresponds to the relative order of that instruction in the program order.

(1) ADD R1←R2+R3

(2) ADD R4←R1+R5

(3) ADD R6←R7+R8

(4) ADD R9←R6+R10

The in-order superscalar processor, while not allowing instructions to be issued strictly out-of-order (i.e., issuing an instruction that occurs later in the program order in an earlier cycle than an instruction that occurs earlier in the program order), does allow an instruction occurring later in the program order to be issued in the same cycle as an instruction occurring earlier in the program order (as long as there are no gaps between them). In this example, the in-order superscalar processor, which can issue up to two instructions per cycle, is able to issue instructions in the following sequence.

Cycle 1: instruction (1)

Cycle 2: instruction (2), instruction (3)

Cycle 3: instruction (4)

Thus, these four instructions take 3 cycles to issue. The processor can issue two instructions in the second cycle because there are no dependencies that prevent those instructions from issuing together (i.e., in the same cycle). Instruction (2) depends on instruction (1), and instruction (4) depends on instruction (3), and these dependencies are satisfied by issuing instruction (1) before instruction (2), and instruction (3) before instruction (4).

The out-of-order superscalar processor also issues up to two instructions per cycle, but is able to issue an instruction that occurs later in the program order in an earlier cycle than an instruction that occurs earlier in the program order. So, in this example, the out-of-order superscalar processor is able to issue instructions in the following sequence.

Cycle 1: instruction (1), instruction (3)

Cycle 2: instruction (2), instruction (4)

With reordering allowed, there is an arrangement of instructions that takes 2 cycles to issue instead of 3 cycles. The same dependencies are still satisfied by issuing instruction (1) before instruction (2), and instruction (3) before instruction (4). But, instruction (3) can now issue out-of-order (i.e., before instruction (2)) since there are no data hazards between instruction (2) and instruction (3) that would prevent it, and instruction (1) does not write to the same register as instruction (3). Thus, out-of-order processors have the potential to improve throughput (i.e., instructions per cycle) significantly.

Potential drawbacks for out-of-order processors include complexity and inefficiency due to aggressive reordering. To issue instructions out of order, a number of future instructions, up to the instruction window size, are examined. However, if there is a control flow change within those future instructions that causes some of them to become invalid, possibly due to miss-speculation, then some of the work performed has been wasted. Instruction overhead for such wasted work can vary greatly (e.g., 16% to 105%). If the instruction overhead is 100%, then the processor is throwing away one instruction for every instruction successfully committed. This instruction overhead has power implications because wasted work wastes energy and therefore power. The complexity in some out-of-order processors can also lead to longer schedules and increased hardware resources (e.g., chip area). By limiting the window size and simplifying the pipeline circuitry in various ways, as described in more detail below, these potential drawbacks of out-of-order processors can be mitigated.

Other features and advantages of the invention will become apparent from the following description, and from the claims.

### DESCRIPTION OF DRAWINGS

FIG. 1 is a schematic diagram of a computing system.

FIG. 2 is a schematic diagram of a processor.

### DESCRIPTION

### 1 Overview

Some out-of-order processors include a significant amount circuitry that is not needed for an in-order processor. However, instead of adding such circuitry (and adding significantly to the complexity), some of the circuitry for implementing a limited out-of-order processor can be obtained by repurposing some of circuitry that already present in many designs for in-order processor pipelines. With relatively modest additions to the pipeline circuitry, a limited out-of-order processor pipeline can be achieved that provides significant performance improvement without sacrificing much power efficiency.

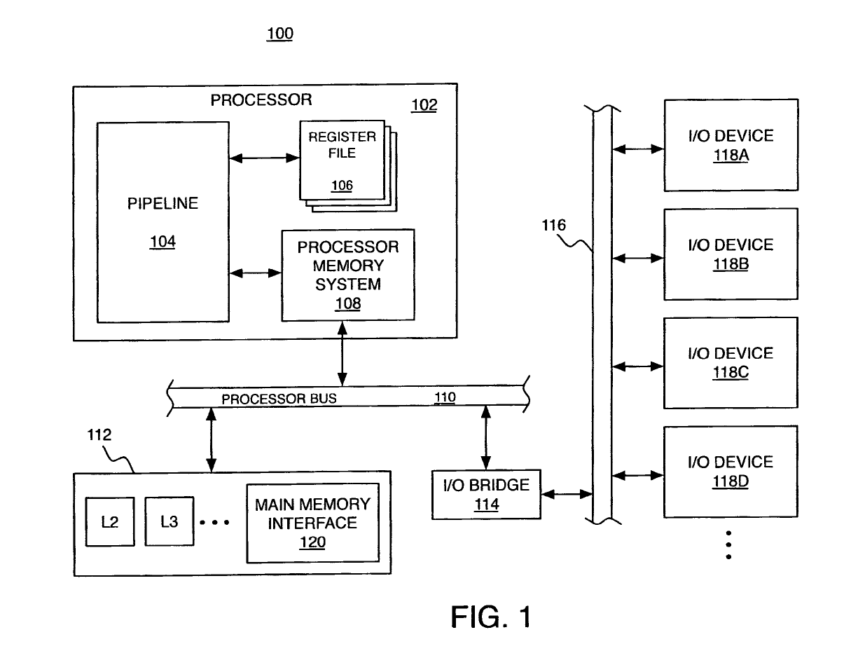

FIG. 1 shows an example of a computing system 100 in which the processors described herein could be used. The system 100 includes at least one processor 102, which could be a single central processing unit (CPU) or an arrangement of multiple processor cores of a multi-core architecture. The processor 102 includes a pipeline 104, one or more register files 106, and a processor memory system 108. The processor 102 is connected to a processor bus 110, which enables communication with an external memory system 112 and an input/output (I/O) bridge 114. The I/O bridge 114 enables communication over an I/O bus 116, with various different I/O devices 118A-118D (e.g., disk controller, network interface, display adapter, and/or user input devices such as a keyboard or mouse).

The processor memory system 108 and external memory system 112 together form a hierarchical memory system that includes a multi-level cache, including at least a first level (L1) cache within the processor memory system 108, and any number of higher level (L2, L3, . . . ) caches within the external memory system 112. Of course, this is only an example. The exact division between which level caches are within the processor memory system 108 and which are in the external memory system 112 can be different in other examples. For example, the L1 cache and the L2 cache could both be internal and the L3 (and higher) cache could be external. The external memory system 112 also includes a main memory interface 120, which is connected to any number of memory modules (not shown) serving as main memory (e.g., Dynamic Random Access Memory modules).

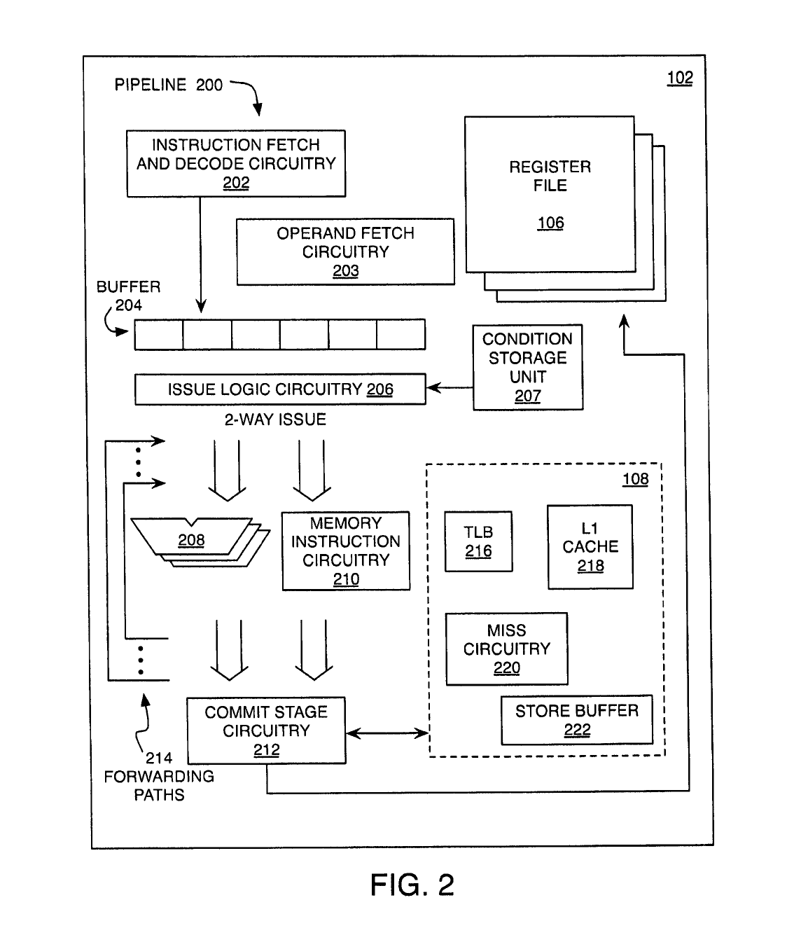

FIG. 2 shows an example in which the processor 102 is a 2-way superscalar processor. The processor 102 includes circuitry for the various stages of a pipeline 200. For one or more instruction fetch and decode stages, instruction fetch and decode circuitry 202 stores information in a buffer 204 for instructions in the instruction window. The instruction window includes instructions that potentially may be issued but have not yet been issued, and instructions that have been issued but have not yet been committed. As instructions are issued, more instructions enter the instruction window for selection among those other instructions that have not yet issued. Instructions leave the instruction window after they have been committed, but not necessarily in one-to-one correspondence with instructions that enter the instruction window. Therefore the size of the instruction window may vary. Instructions enter the instruction window in-order and leave the instruction window in-order, but may be issued and executed out-of-order within the window. One or more operand fetch stages also include operand fetch circuitry 203 to store operands for those instructions in the appropriate operand registers of the register file 106.

There may be multiple separate paths through one or more execution stages of the pipeline (also called a ‘dynamic execution core’), which include various circuitry for executing instructions. In this example, there are multiple functional units 208 (e.g., ALU, multiplier, floating point unit) and there is memory instruction circuitry 210 for executing memory instructions. So, an ALU instruction and a memory instruction, or different types of ALU instructions that use different ALUs, could potentially pass through the same execution stages at the same time. However, the number of paths through the execution stages is generally dependent on the specific architecture, and may differ from the issue width. Issue logic circuitry 206 is coupled to a condition storage unit 207, and determines in which cycle instructions in the buffer 204 are to be issued, which starts their progress through circuitry of the execution stages, including through the functional units 208 and/or memory instruction circuitry 210. There is at least one commit stage that uses commit stage circuitry 212 to commit results of instructions that have made their way through the execution stages. For example, a result may be written back into the register file 106. There are forwarding paths 214 (also known as ‘bypass paths’), which enable results from various execution stages to be supplied to earlier stages before those results have made their way through the pipeline to the commit stage. This commit stage circuitry 212 commits instructions in-order. To accomplish this, the commit stage circuitry 212 may optionally use the forwarding paths 214 to help restore program order for instructions that were issued and executed out-of-order, as described in more detail below. The processor memory system 108 includes a translation lookaside buffer (TLB) 216, an L1 cache 218, miss circuitry 220 (e.g., including a miss address file (MAF)), and a store buffer 222. When a load or store instruction is executed, the TLB 216 is used to translate an address of that instruction from a virtual address to a physical address, and to determine whether a copy of that address is in the L1 cache 218. If so, that instruction can be executed from the L1 cache 218. If not, that instruction can be handled by miss circuitry 220 to be executed from the external memory system 112, with values that are to be transmitted for storage in the external memory system 112 temporarily held in the store buffer 222.

There are four broad aspects of the design of the processor pipeline 200, introduced in this section, and described in more detail in the following sections.

A first aspect of the design is register lifetime management. Register lifetime refers to the amount of time (e.g., number of cycles) between allocation and release of particular physical register for storing different operands and/or results of different instructions. During a register's lifetime, a particular value supplied to that register as a result of one instruction may be read as an operand by a number of other instructions. Register recycling schemes can be used to increase the number of physical registers available beyond a fixed number of architectural registers defined by an instruction set architecture (ISA). In some embodiments, recycling schemes use register renaming, which involves selecting a physical register from a ‘free list’ to be renamed, and returning the physical register identifier to the free list after it has been allocated, used, and released. Alternatively, in some embodiments, in order to more efficiently manage the recycling of registers, multi-dimensional register identifiers can be used in the pipeline 200 instead of register renaming to avoid the need for all of the management activities that are sometimes needed by register renaming schemes.

A second aspect of the design is issue management. For an in-order processor, the issue circuitry of the pipeline is limited to a number of contiguous instructions within the issue width for selecting instructions that could potentially issue in the same cycle. For an out-of-order processor, the issue circuitry is able to select from a larger window of contiguous instructions, called the instruction window (also called the ‘issue window’). In order to the manage information that determines whether particular instructions within the instruction window are eligible to be issued, some processors use a two-stage process that relies on circuitry called ‘wake-up logic’ to perform instruction wake up, and circuitry called ‘select logic’ to perform instruction selection. The wake-up logic monitors various flags that determine when an instruction is ready to be issued. For example, an instruction in the instruction window that is waiting to be issued may have tags for each operand, and the wake-up logic compares tags broadcast when various operands have been stored in designated registers as a result of previously issued and executed instructions. In such a two-stage process, an instruction is ready to issue when all of the tags have been received over a broadcast bus. The select logic applies a scheduling heuristic for selecting instructions to issue in any give cycle from among the ready instructions. Instead of using this two-stage process, circuitry for selecting instructions to issue can directly detect conditions that need to be satisfied for each instruction, and avoid the need for the broadcasting and comparing of tags typically performed by the wake-up logic.

A third aspect of the design is memory management. Some out-of-order processors dedicate a potentially large amount of circuitry for reordering memory instructions. By classifying instructions into multiple classes, and designating at least some classes of memory instructions for which out-of-order execution is not allowed, the pipeline 200 can rely on circuitry for performing memory operations that is significantly simplified, as described in more detail below. A class of instructions can be defined in terms of the operation codes (or ‘opcodes’) that define the operation to be performed when executing an instruction. This class of instructions may be indicated as having to be executed in-order with respect to all instructions, or with respect to at least a particular class of other instructions (also determined by their opcodes). In some implementations, such instructions are prevented from issuing out-of-order. In other implementations, the instructions are allowed to issue out-of-order, but are prevented from executing out-of-order after they have been issued. In some cases, if an instruction issued out-of-order but has not yet changed any processor state (e.g., values in a register file) the issuing of that instruction can be reversed, and that instruction can return to a state of waiting to issue.

A fourth aspect of the design is commit management. Some out-of-order processors use a reorder buffer to temporarily store results of instructions and allow the instructions to be committed in-order. This ensures that the processor is able to take precise exceptions, as described in more detail below. By limiting the situations that would lead to instructions potentially being committed out-of-order, those situations can be handled in a manner that takes advantage of pipeline circuitry already being used for other purposes, and circuitry such as a reorder buffer can be avoided in the reduced complexity pipeline 200.

### 2 Register Lifetime Management

To describe register lifetime management for the processor pipeline 200 in more detail, another example of a sequence of instructions is considered.

(1) ADD R1←R2+R3

(2) ADD R4←R1+R5

(3) ADD R1←R7+R8

(4) ADD R9←R1+R10

Unlike the previous example of issuing instructions out-of-order, in this example, instruction (1) and instruction (3) cannot issue in the same cycle because both are writing register R1. Some out-of-order processors use register renaming to map the identifiers for different architectural registers that show up in the instructions to other register identifiers, corresponding to a list of physical registers available in one or more register files in the processor. For example, R1 in instruction (1), and R1 in instruction (3) would map to different physical registers so that instruction (1) and instruction (3) are allowed to issue in the same cycle. Alternatively, in order to reduce the circuitry needed in various stages of the pipeline 200 and the amount of work needed to maintain a register renaming map, the following multi-dimensional register identifiers can be used. For example, in some implementations, fewer pipeline stages are needed to manage the multi-dimensional register identifiers than would be needed for performing register renaming.

The processor 102 includes multiple physical registers for each architectural register identifier. For multi-dimensional register identifiers, the number of physical registers may be equal to a multiple of the number of architectural registers (called the ‘register expansion factor’). For example, if there are 16 architectural register identifiers (R1-R16), the register file 106 may have 64 individually addressable storage locations (i.e., a register expansion factor of 4). A first dimension of the multi-dimensional register identifier has a one-to-one correspondence with the architectural register identifiers, such that number of values of the first dimension is equal to the number of different architectural register identifiers. A second dimension of the multi-dimensional register identifier has a number of values equal to the register expansion factor. In this example, the storage locations of the register file 106 can be addressed by a logical address built from the dimensions of the multi-dimensional identifier: the first dimension corresponding to the 4 high-order logical address bits, and the second dimension corresponding to the 2 low-order logical address bits. Alternatively, in other implementations, the processor 102 could include multiple register files, and the second dimension could correspond to a particular register file, and the first dimension could correspond to a particular storage location within a particular register file.

Since there is a one-to-one correspondence between the first dimension and the architectural register identifiers, the register identifiers within each instruction can be assigned directly to the first dimension of the multi-dimensional register identifier. The second dimension can then be selected based on register state information that tracks how many of the physical registers associated with that architectural register identifier are available. In the example above, the destination register for instruction (1) can be assigned to the multi-dimensional register identifier <R1, 0>, and the destination register for instruction (3) can be assigned to the multi-dimensional register identifier <R1, 1>. The assignment of physical registers based on architectural register identifiers included in different instructions can be managed by dedicated circuitry within the processor 102, or by circuitry that also manages other functions, such as the issue logic circuitry 206, which uses the condition storage unit 207 to keep track of when conditions such as data hazards are resolved. If, according to the register state information, there are no available physical registers for a given architectural register R9, then the issue logic circuitry 206 will not be able to issue any further instructions that would write to register R9 until at least one of the physical registers associated with R9 is released. In the example above, if the register expansion factor were equal to 2, and instruction (1) writes to <R1, 0> and instruction (3) writes to <R1, 1> in the same cycle, then another instruction that writes to R1 could not be issued until instruction (2) has read <R1, 0> and <R1, 0> is made available again.

### 3 Issue Management

The issue logic circuitry 206 is configured to monitor a variety of conditions related to determining whether any of the instructions in the instruction window can be issued in any given cycle. For example, the conditions include structural hazards (e.g., a particular functional unit 208 is busy), data hazards (e.g., dependencies between a read operation and a write operation, or between two write operations, to the same register), and control hazards (e.g., the outcome of a previous branch instruction is not known). In an in-order processor, the issue logic only needs to monitor conditions for a small number of instructions equal to the issue width (e.g., 2 for a 2-way superscalar processor, or 4 for a 4-way superscalar processor). In an out-of-order processor, since the instruction window size can be larger than the issue width, there are potentially a much larger number of instructions for which these conditions need to be monitored.

Some out-of-order processors use wake-up logic to monitor various conditions on which instructions may depend. For example, the wake-up logic typically includes at least one tag bus over which tags are broadcast, and comparison logic for matching tags for operands of instructions waiting to be issued (e.g., instructions in a ‘reservation station’) to corresponding tags that are broadcast over the tag bus after values of those operands are produced by executed instructions. However, instead of requiring the processor 102 to include such wake-up logic circuitry and tag bus, by limiting the instruction window size to a relatively small factor of the issue width (e.g., a factor of 2, 3, or 4) it becomes feasible to include circuitry as part of the issue logic circuitry 206 to perform a direct lookup operation into the condition storage unit 207 for each instruction in the instruction window.

The condition storage unit 207 can use any of a variety of techniques for tracking the conditions, including techniques known as ‘scoreboarding’ using scoreboard tables. Instead of waiting for condition information to be ‘pushed’ to the instructions in the instruction window (e.g., via tags that are broadcast), the condition information is ‘pulled’ directly from the condition storage unit 207 each cycle. The decision of whether or not to issue an instruction in the current cycle is made on a cycle-by-cycle basis, according to that condition information. Some of the decisions are ‘dependent decisions’, where the issue logic decides whether an instruction that has not yet issued depends on a prior instruction (according to program order) that has also not yet issued. Some of the decisions are ‘independent decisions’, where the issue logic decides independently whether an instruction that has not yet issued can be issued in that cycle. For example, the pipeline may be in a state such that no instruction can issue in that cycle, or the instruction may not have all of its operands stored yet. Some of the decisions will be made based on results of lookup operations into the condition storage unit 207. The issue logic circuitry 206 includes circuitry that represents a logic tree including each decision and resulting in a single Boolean value for each instruction in the instruction window, indicating whether or not that instruction can be issued in the current cycle. For example, the logic tree would include decisions on whether a particular source operand is ready, whether a particular functional unit will be free in the cycle the instruction will execute, whether a prior hazard in the pipeline prevents the issue of the instruction, etc. A number of instructions, up to the issue width, can then be selected from those instructions to be issued in the current cycle.

### 4 Memory Management

The issue logic circuitry 206 is also configured to selectively limit the classes of instructions that are allowed to be issued out-of-order with respect to certain other instructions. Instructions may be classified by classifying the opcodes obtained when those instructions are decoded. So, the issue logic circuitry 206 includes circuitry that compares the opcode of each instruction to different predetermined classes of opcodes. In particular, it may be useful to limit the reordering of instructions whose opcode indicates a ‘load’ or ‘store’ operation. Such load or store instructions could potentially be either memory instructions, if storing or loading to or from memory; or I/O instructions, of storing or loading to or from an I/O device. It may not be apparent what kind of a load or store instruction it is until after it issues and the translated address reveals if the target address is a physical memory address or an I/O device address. Memory load instructions load data from the memory system 106 (at a particular physical memory address, which may be translated from a virtual address to a physical address), and memory store instructions store a value (an operand of the store instruction) into the memory system 106.

Some memory management circuitry is only needed if it is possible for certain types of memory instructions to be issued out-of-order with respect to certain other types of memory instructions. For example, certain complex load buffers are not needed for in-order processors. Other memory management circuitry is used for both out-of-order processors and in-order processors. For example, simple store buffers are used even by in-order processors to carry the data to be stored through the pipeline to the commit stage. By limiting reordering of memory instructions, certain potentially complex circuitry can be simplified, or eliminated entirely, from the circuitry that handles memory instructions, such as the memory instruction circuitry 210 or the processor memory system 108.

In some implementations, there are two classes of instructions and reordering is allowed for instructions in the first class, but reordering is not allowed for instructions in the second class with respect to other instructions in the second class. For example, the second class may include all load or store instructions. In one example, a load or store instruction would not be allowed to issue before another load or store instruction that occurs earlier in the program order, or after another load or store instruction that occurs later in the program order. However, the first class, which includes all other instructions, could potentially be issued out-of-order with respect to any other instruction, including load or store instructions. Disallowing reordering among load or store instructions sacrifices the potential increase in performance that could have been achieved from out-of-order load or store instructions, but enables simplified memory management circuitry.

In some implementations, reordering constraints for a class of instructions may be defined in terms of a set of target opcodes that is different from the set of opcodes that define the class of instructions itself. The reordering constraints can also be asymmetric, for example, such that an instruction with opcode A cannot bypass (i.e., be issued before and out-of-order with) an instruction with opcode B, but an instruction with opcode B can bypass an instruction with opcode A. Other information, in addition to the opcode may also be used to define a class of instructions. For example, the address may be needed to determine whether an instruction is a memory load or store instruction or an I/O load or store instruction. One bit in the address may indicate whether the instruction is a memory or I/O instruction, and the remaining bits may be interpreted additional address bits within a memory space, or for selecting an I/O device and a location within that I/O device.

In another example, all load or store instructions may be assumed to be memory load or store instructions until a stage at which the address is available and I/O load or store instructions may be handled differently before the commit stage (as described in more detail in the following section describing commit management). In this example, memory store instructions are in a first class of instructions that are not allowed to bypass other memory store instructions or any memory load instructions. Memory load instructions are in a second class of instructions that are allowed to bypass other memory load instructions and certain memory store instructions. A memory load instruction that issues out-of-order with respect to another memory load instruction does not cause any inconsistencies with respect to the memory system 106 since there is inherently no dependency between the two instructions. In this example, a memory load instruction is allowed to bypass a memory store instruction. However, before allowing the memory load instruction to be executed before the memory store instruction, the memory addresses of those instructions are analyzed to determine if hey are the same. If they are not the same, then the out-of-order execution may proceed. But, if they are the same, the memory load instruction is not allowed to proceed to the execution stage (even if it had already been issued out-of-order, it can be halted before execution).

Other examples of reordering constraints for different classes of memory instructions can be designed to reduce the complexity of the processor's circuitry. The circuitry required to handle limited cases of out-of-order issuing of memory instructions is not as complex as the circuitry that would be required to handle full out-of-order issuing of memory instructions. For example, if memory store instructions are allowed to bypass memory load instructions, then the commit stage circuitry 212 ensures that the memory store instruction is not committed if the memory addresses are the same. This can be achieved, for example, by discarding the memory store instruction from the store buffer 222 when its memory address matches the memory address of a bypassed memory load instruction. Generally, the commit stage circuitry 212 is configured to ensure that a memory load or store instruction is not committed when it issues out-of-order until and unless it is confirmed to be safe to commit the instruction.

### 5 Commit Management

Typically, all instructions, even instructions that can be issued out-of-order, must be committed (or retired) in-order. This constraint helps with the management of precise exceptions, which means that when there is an excepting instruction, the processor ensures that all instructions before the excepting instruction have been committed and no instructions after the excepting instruction have been committed. Some out-of-order processors have a reorder buffer from which instructions are committed in the commit stage. The reorder buffer would store information about completed instructions, and the commit stage circuitry would commit instructions in program order, even if they were executed out-of-order.

However, the processor 102 is able to manage precise exceptions without using a reorder buffer at the commit stage because the forwarding paths 214 in the pipeline 200 store the results of executed instructions in buffers of one or more previous stages as those results make their way through the pipeline until the architectural state of the processor is updated at the end of the pipeline 200 (e.g., by storing a result in register file 106, or by releasing a value to be stored into the external memory system 112 out of the store buffer 222). The commit stage circuitry 212 uses results from the forwarding paths 214 to update architectural state, if necessary, when committing instructions in program order. If an instruction or sequence of instructions must be discarded, the commit stage circuitry 212 is configured to ensure that the forwarding paths 214 are not used to update architectural state until and after all prior instructions have been cleared of all exceptions. In some implementations, the processor 102 is also configured to ensure that for certain long-running instructions that may potentially raise an exception, the issue and/or execution of the instructions are delayed to ensure the property that exceptions are precise.

The processor 102 can also include circuitry to perform re-execution (or ‘replaying’) of certain instructions if necessary, such as in response to a fault. For example, memory instructions, such as memory load or store instructions, that execute out-of-order and take a fault (e.g., for a TLB miss), can be replayed through the pipeline 200 in-order. As another example, there is a class of instructions, such as I/O load instructions, that must be executed non-speculatively and in-order. This is often referred to as the instruction being executed at commit. However, a load instruction may be in a class of instructions that are allowed to be issued out-of-order with respect to other load instructions (as described in the previous section on memory management). A potential problem is that it may not be known if two load instructions issued out-of-order with respect to each other are I/O load instructions that cannot be executed out-of-order (as opposed to memory load instructions that can be executed out-of-order) until the processor 102 references the TLB 216. After the TLB 216 is referenced, and it is determined that the first load instruction is an I/O load instruction, one way that could potentially be used to prevent the I/O load instruction from proceeding through the pipeline to be executed out-of-order would be to replay the I/O load instruction so that it executes strictly in-order (to simulate the effect of execute at commit), but that could potentially be an expensive solution since replaying the I/O load instruction would cause work performed for all instructions issued after that I/O load instruction to be lost. Instead, the processor 102 is able to propagate the I/O load instruction to the processor memory system 108, where it be held temporarily in the miss circuitry 220, and then serviced from the miss circuitry 220. The miss circuitry 220 stores a list (e.g., a miss address file (MAF)) of load and store instructions to be serviced, and waits for data to be returned for a load instruction, and an acknowledgement that data has been stored for a store instruction. If the I/O load instruction started to execute out-of-order, the commit stage circuitry 212 ensures that the I/O load instruction does not reach the MAF if there are any other instructions that are before the I/O load instruction in the program order that must be issued first (e.g., other I/O load instructions). Otherwise, the I/O load instruction can proceed to the MAF and be executed out-of-order. Alternatively, the I/O load instruction can be held in the MAF until the front-end of the pipeline determines that the I/O load instruction is non-speculative (that is, all memory instructions prior to the I/O load instructions are going to commit) and sends that indication to the MAF to issue the I/O load instruction.

Other embodiments are within the scope of the following claims.

What is claimed is:

1. A method for executing instructions in a processor, the method comprising:
classifying, in at least one stage of a pipeline of the processor, operations to be performed by instructions, the classifying including:
classifying a first set of operations as operations for which out-of-order execution is allowed, and
classifying a second set of operations as operations for which out-of-order execution with respect to one or more specified operations is not allowed, the second set of operations including at least store operations; and
selecting results of instructions executed out-of-order to commit the selected results in-order, the selecting including, for a first result of a first instruction and a second result of a second instruction executed before and out-of-order relative to the first instruction:
determining which stage of the pipeline stores the second result, and
committing the first result directly from the determined stage over a forwarding path, before committing the second result.

2. The method of claim 1, wherein the second set of operations further includes load operations.

3. The method of claim 1, further comprising selecting a plurality of instructions to be issued to one or more stages of the pipeline in which multiple sequences of instructions are executed in parallel through separate paths through the pipeline, based at least in part on a Boolean value provided by circuitry that applies logic to condition information stored in the processor representing conditions for multiple instructions in the set.

4. The method of claim 3, wherein the condition information comprises one or more scoreboard tables.

5. The method of claim 3, further comprising:
determining identifiers corresponding to instructions in at least one decode stage of the pipeline, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
assigning a multi-dimensional identifier to at least one storage identifier.

6. The method of claim 3, further comprising:
determining identifiers corresponding to instructions in at least one decode stage of the pipeline, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
renaming at least one storage identifier to a physical storage identifier corresponding to a set of physical storage locations that has more physical storage locations than a total number of storage identifiers appearing in decoded instructions.

7. The method of claim 1, further comprising:
determining identifiers corresponding to instructions in at least one decode stage of the pipeline, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
assigning a multi-dimensional identifier to at least one storage identifier.

8. The method of claim 1, further comprising:
determining identifiers corresponding to instructions in at least one decode stage of the pipeline, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
renaming at least one storage identifier to a physical storage identifier corresponding to a set of physical storage locations that has more physical storage locations than a total number of storage identifiers appearing in decoded instructions.

9. A processor, comprising:
circuitry in at least one stage of a pipeline of the processor configured to classify operations to be performed by instructions, the classifying including:
classifying a first set of operations as operations for which out-of-order execution is allowed, and
classifying a second set of operations as operations for which out-of-order execution with respect to one or more specified operations is not allowed, the second set of operations including at least store operations; and
circuitry in at least one stage of the pipeline of the processor configured to select results of instructions executed out-of-order to commit the selected results in-order, the selecting including, for a first result of a first instruction and a second result of a second instruction executed before and out-of-order relative to the first instruction:
determining which stage of the pipeline stores the second result, and
committing the first result directly from the determined stage over a forwarding path, before committing the second result.

10. The processor of claim 9, wherein the second set of operations further includes load operations.

11. The processor of claim 9, further comprising circuitry configured to select a plurality of instructions to be issued to one or more stages of the pipeline in which multiple sequences of instructions are executed in parallel through separate paths through the pipeline, based at least in part on a Boolean value provided by circuitry that applies logic to condition information stored in the processor representing conditions for multiple instructions in the set.

12. The processor of claim 11, wherein the condition information comprises one or more scoreboard tables.

13. The processor of claim 11, further comprising:
circuitry in at least one decode stage of the pipeline configured to determine identifiers corresponding to instructions, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
circuitry configured to assign a multi-dimensional identifier to at least one storage identifier.

14. The processor of claim 11, further comprising:
circuitry in at least one decode stage of the pipeline configured to determine identifiers corresponding to instructions, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
circuitry configured to rename at least one storage identifier to a physical storage identifier corresponding to a set of physical storage locations that has more physical storage locations than a total number of storage identifiers appearing in decoded instructions.

15. The processor of claim 9, further comprising:
circuitry in at least one decode stage of the pipeline configured to determine identifiers corresponding to instructions, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
circuitry configured to assign a multi-dimensional identifier to at least one storage identifier.

16. The processor of claim 9, further comprising:
circuitry in at least one decode stage of the pipeline configured to determine identifiers corresponding to instructions, with a set of identifiers for at least one instruction including:
at least one operation identifier identifying an operation to be performed by the instruction,
at least one storage identifier identifying a storage location for storing an operand of the operation, and
at least one storage identifier identifying a storage location for storing a result of the operation; and
circuitry configured to rename at least one storage identifier to a physical storage identifier corresponding to a set of physical storage locations that has more physical storage locations than a total number of storage identifiers appearing in decoded instructions.
